(19) United States
(12) Patent Application Publication
(10) Pub. No.: US 2026/0142565 A1
(43) Pub. Date: May 21, 2026

(54) REVERSE INTERLEAVED BOOST POWER FACTOR CORRECTION TOPOLOGY

(71) Applicant: Franklin Electric Co., Inc., Fort Wayne, IN (US)

(72) Inventors: Benjamin W. HUNLEY, Yoder, IN (US); Jason L. CONEY, Columbia City, IN (US); Justin A. ANTEAU, Roanoke, IN (US)

(21) Appl. No.: 19/393,765

(22) Filed: Nov. 19, 2025

Related U.S. Application Data
(60) Provisional application No. 63/722,127, filed on Nov. 19, 2024.

(51) Int. Cl. H02M 1/42; H02M 1/00; H02M 7/483; H02M 7/5395

(52) U.S. Cl. CPC H02M 1/4216; H02M 1/0009; H02M 7/483; H02M 7/5395

(57) ABSTRACT

The present disclosure provides a variable frequency drive with active power factor correction circuit topology to facilitate unity power factor and non-positive DC bias on the output voltage. The topology is an improvement over the traditional boost power factor correction circuit consisting of a bridge rectifier, a plurality of inductors, a plurality of power semiconductor transistor switches, a plurality of boost diodes, a bus capacitor bank and a controller. In certain embodiments, the active power factor correction circuit feeds an inverter circuit that drives a motor.

### CROSS-REFERENCE TO RELATED APPLICATIONS

The present application claims the benefit of U.S. Provisional Application No. 63/722,127, filed November 19, 2024, the entire disclosure of which is incorporated by reference herein.

### FIELD OF THE DISCLOSURE

The present disclosure pertains to power factor correction, and more specifically to an active power factor correction topology to facilitate unity power factor and non-positive DC bias on the output voltage.

### BACKGROUND

Variable frequency drives for controlling pumps are known. It is desirable to provide a variable frequency drive with an active power factor correction topology that facilitates unity power factor and non-positive DC bias on the output voltage. It is also desirable that such a variable frequency drive be able to accept both single-phase and three-phase input power.

### SUMMARY

In one embodiment, the present disclosure provides a variable frequency drive with an active power factor correction circuit equipped at the front end of the electronic system. The active power factor correction circuit topology according to the present disclosure is an improvement over the traditional boost power factor correction consisting of a bridge rectifier, a plurality of inductors, a plurality of power semiconductor transistor switches, a plurality of boost diodes, a bus capacitor bank and a controller. In certain embodiments, the active power factor correction circuit feeds an inverter circuit that drives a coupled motor.

In one embodiment, the present disclosure provides a drive circuit, comprising: a rectifier configured to rectify AC power; a capacitor coupled in parallel to an output of the rectifier; a power factor correction (“PFC”) circuit coupled to the rectifier output and having a DC+ node and a DC- node; a bus capacitor having a positive end coupled to the DC+ node and a negative end coupled to the DC- node; wherein the PFC circuit includes a plurality of channels, each channel comprising: a current sensor having a negative side coupled to a negative side of the rectifier output; a switch having an output node coupled to the DC+ node; an inductor coupled between a positive side of the current sensor and an input node of the switch; a diode having a cathode coupled to the input node of the switch and an anode coupled to the DC- node; and a driver circuit having a control connection coupled to a control node of the switch and an input connection coupled to the input node of the switch; and a controller configured to control the PFC circuit to connect the inductor of each of the plurality of channels to the DC+ node independently of inductors of other channels of the plurality of channels, and to connect the inductor of each of the plurality of channels to the DC- node independently of inductors of other channels of the plurality of channels to charge the bus capacitor through the inductors and the diodes of each of the plurality of channels independently with current from the diodes of the plurality of channels. In one aspect of this embodiment, the rectifier is a three phase rectifier. In another aspect, the drive circuit further comprises an inverter configured to receive a DC signal from the PFC circuit and provide a pulse width modulated output voltage to a motor. In a variant of this aspect, an average of the output voltage of the inverter has a negative DC bias. In another aspect, the switch is a MOSFET.

In another embodiment, the present disclosure provides a drive circuit, comprising: a rectifier configured to rectify AC power; a capacitor coupled in parallel to an output of the rectifier; a power factor correction (“PFC”) circuit coupled to the rectifier output and having a DC+ node and a DC- node; a bus capacitor having a positive end coupled to the DC+ node and a negative end coupled to the DC- node; wherein the PFC circuit includes at least one channel comprising: a current sensor having a negative side coupled to a negative side of the rectifier output; a switch having an output node coupled to the DC+ node; a first inductor coupled between a positive side of the current sensor and an input node of the switch; a diode having a cathode coupled to the input node of the switch and an anode coupled to the DC- node; a second inductor coupled between a positive side of the rectifier output and the output node of the switch; and a driver circuit having a control connection coupled to a control node of the switch and an input connection coupled to the input node of the switch; and a controller configured to control the PFC circuit to connect the second inductor to the positive end of the bus capacitor and to connect the first inductor to the negative end of the bus capacitor to charge the bus capacitor through the first inductor, the second inductor and the diode with current from the diode. In one aspect of this embodiment, the rectifier is a three phase rectifier. In another aspect, the drive circuit further comprises an inverter configured to receive a DC signal from the PFC circuit and provide a pulse width modulated output voltage to a motor. In a variant of this aspect, an average of the output voltage of the inverter has a negative DC bias.

In yet another embodiment, the present disclosure provides a method of providing power factor correction of a drive signal for a motor, comprising: rectifying an AC power input with a rectifier; coupling a capacitor in parallel with an output of the rectifier; coupling a power factor correction (“PFC”) circuit to the rectifier output, the PFC circuit having a DC+ node and a DC- node; smoothing an output of the PFC circuit with a bus capacitor having a positive end coupled to the DC+ node and a negative end coupled to the DC- node; wherein the PFC circuit includes a plurality of channels, each channel comprising: a current sensor having a negative side coupled to a negative side of the rectifier output; a switch having an output node coupled to the DC+ node; an inductor coupled between a positive side of the current sensor and an input node of the switch; a diode having a cathode coupled to the input node of the switch and an anode coupled to the DC- node; and a driver circuit having a control connection coupled to a control node of the switch and an input connection coupled to the input node of the switch; and controlling the PFC circuit to connect the inductor of each of the plurality of channels to the DC+ node independently of inductors of other channels of the plurality of channels, and to connect the inductor of each of the plurality of channels to the DC- node independently of inductors of other channels of the plurality of channels to charge the bus capacitor through the inductors and the diodes of each of the plurality of channels independently with current from the diodes of the plurality of channels. In one aspect of this embodiment, the rectifier is a three phase rectifier. Another aspect further comprises converting a DC signal from the PFC circuit with an inverter to provide a pulse width modulated output voltage to the motor. In a variant of this aspect, an average of the output voltage of the inverter has a negative DC bias. In another aspect, the switch is a MOSFET.

### BRIEF DESCRIPTION OF THE DRAWINGS

The above-mentioned and other advantages and objects of this invention, and the manner of attaining them, will become more apparent, and the invention itself will be better understood, by reference to the following description of embodiments of the invention taken in conjunction with the accompanying drawings, wherein:

FIG. 1 is a schematic diagram of a variable frequency drive with a reverse interleaved boost power factor correction topology according to one embodiment of the present disclosure;

FIG. 2 is a schematic diagram of a known active power factor correction circuit with a single-phase bridge rectifier;

FIG. 3 is a schematic diagram of known interleaved active power factor correction circuit with a single-phase bridge rectifier;

FIG. 4 is a schematic diagram of another known interleaved active power factor correction circuit with a three-phase bridge rectifier;

FIG. 5 is a graph depicting the positive and negative DC bus voltages of a known active power factor correction circuit;

FIG. 6 is a graph depicting the positive and negative DC bus voltages of a variable frequency drive with a reverse interleaved boost power factor correction topology as depicted in FIG. 1; and

FIG. 7 is a schematic diagram of a single channel derivative of the reverse interleaved boost power factor correction topology of FIG. 1.

Corresponding reference characters indicate corresponding parts throughout the several views. Although the drawings represent embodiments of the present disclosure, the drawings are not necessarily to scale, and certain features may be exaggerated or omitted in some of the drawings in order to better illustrate and explain the present disclosure.

### DETAILED DESCRIPTION

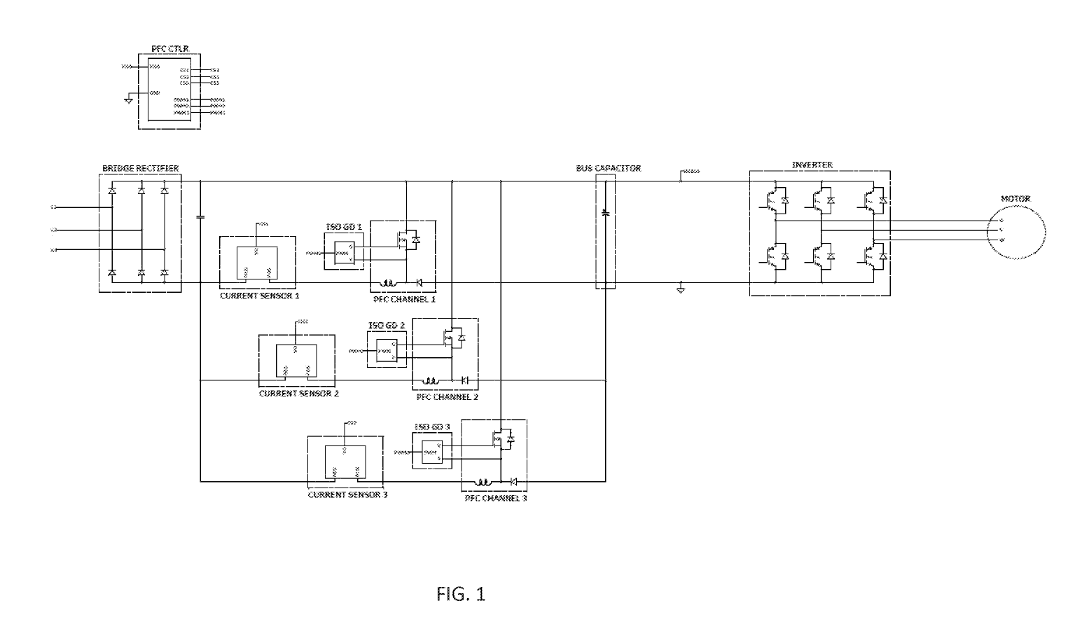

Referring now to FIG. 1, the present disclosure provides a variable frequency drive with an active power factor correction equipped to the front end of the electronic system. The active power factor correction circuit topology is an improvement over the traditional interleaved boost power factor correction consisting of a bridge rectifier, a plurality of inductors, a plurality of power semiconductor transistor switches, a plurality of boost diodes, a bus capacitor bank and a controller. In certain embodiments, the active power factor correction circuit feeds an inverter circuit that drives a coupled motor.

In the embodiment depicted in FIG. 1, the circuit includes at least three input connections, each input connection being configured to receive a conductor of an AC power source. A rectifier is electrically connected to input connections and includes a plurality of diodes configured to rectify single phase AC power or three phase AC power. While a three phase rectifier is shown, a single phase rectifier could easily be implemented by a person of ordinary skill in the art. The rectifier has a positive side and negative side of the output. A capacitor is electrically connected in parallel to the rectifier output. An active power factor correction circuit is electrically connected to the rectifier output and may include multiple interleaved channels. Each channel includes a current sensor having a positive side and a negative side coupled to the negative side of the rectifier, an inductor having a first end coupled to the positive side of the current sensor and a second end, a boost diode having a cathode coupled to the second end of the inductor and an anode coupled to the DC- of the active power factor correction circuit, a power semiconductor transistor switch with a drain, a source and a gate, wherein the source is coupled to both the second end of the inductor and the cathode of the diode and the drain is coupled to DC+ of the active power factor correction circuit, an isolated gate driver circuit having a gate connection coupled to the power semiconductor switch gate and source connection coupled to the source of the power semiconductor switch. While FIG. 1 depicts the switch as an N-channel metal oxide semiconductor field effect transistor (“MOSFET”), any suitable power semiconductor switch may be used, such as an insulated-gate bipolar transistor, wherein references above to the source would be replaced with the collector and references to the drain would be replaced with the emitter. The source and the collector may be referred to as an input node, the drain and the emitter may be referred to as an output node, and the gate may be referred to as a control node. The circuit further includes a bus capacitor bank having a positive end coupled to the DC+ of the active power factor correction circuit and a negative end coupled to the DC- of the active power factor correction circuit. Finally, the circuit includes a controller configured to electrically connect each of the multiple inductors to DC+ of the active power factor correction circuit independently of the other inductors and to electrically connect each of the multiple inductors to the negative end of the capacitor independently of the other inductors to charge the capacitor through each of the inductors and each of the diodes in the active power factor correction circuit independently with current from the diodes in the active power factor correction circuit.

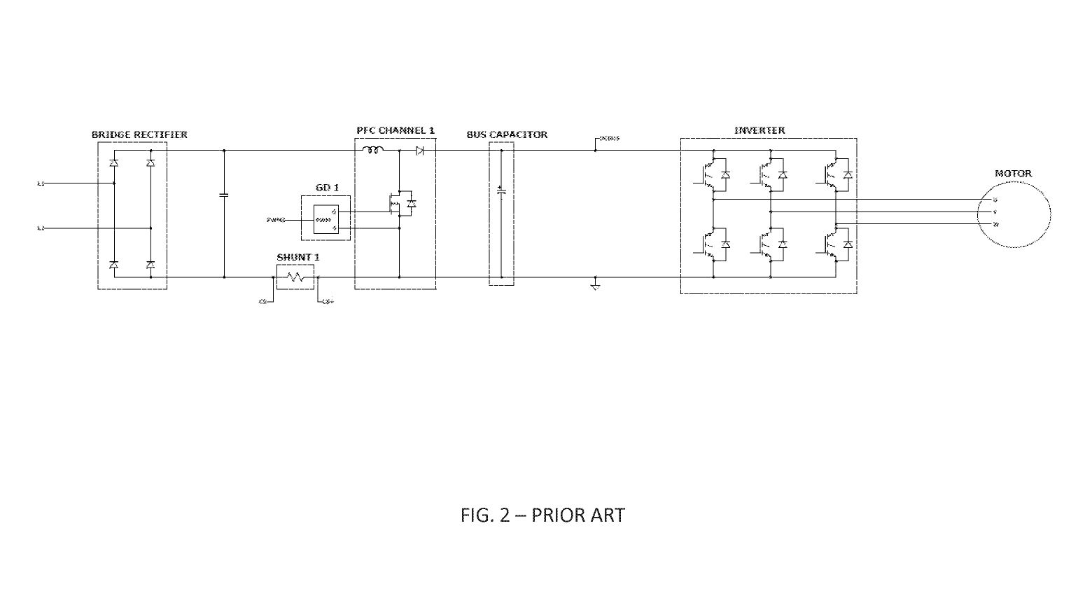

FIG. 2 depicts a simple boost power factor correction circuit. While this circuit is simple and achieves the primary goal of active power factor correction, unity power factor in the ideal, it is not scalable due to the entirety of the input current flowing through the inductor. Therefore, the design is not practical for larger power levels due to the inductor design becoming unreasonable as output power increases. The same is true for the boost diode and power semiconductor transistor switch.

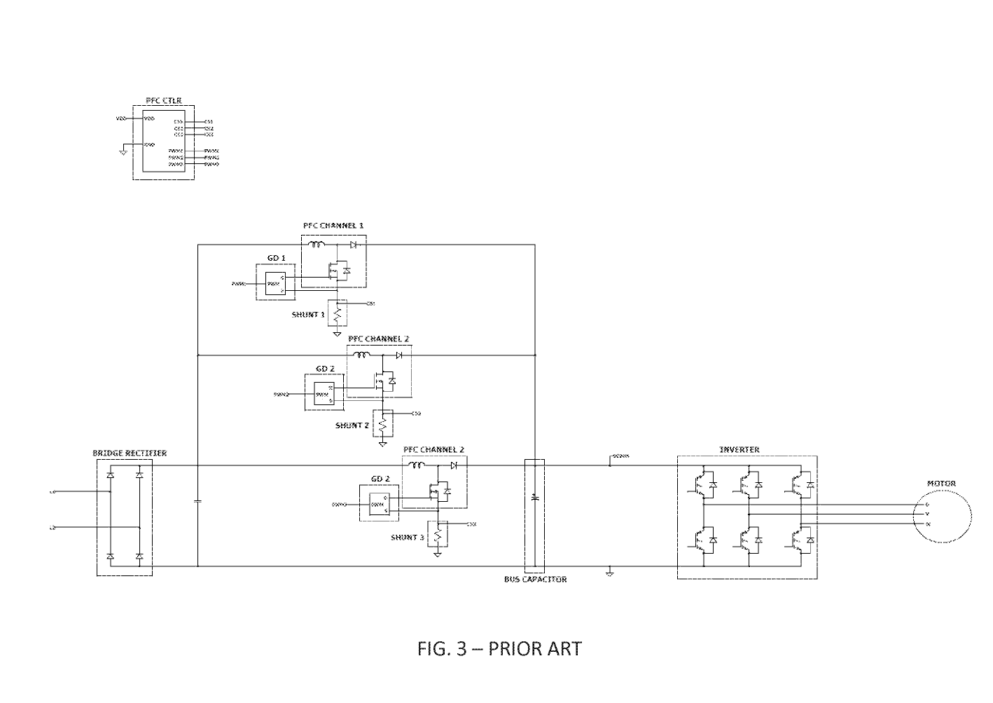

To obtain more power, it is possible to parallel the power factor correction stages and interleave the parallel stages, or channels. Past standard solutions for an interleaved boost power factor correction circuit are typically configured as depicted in FIG. 3.

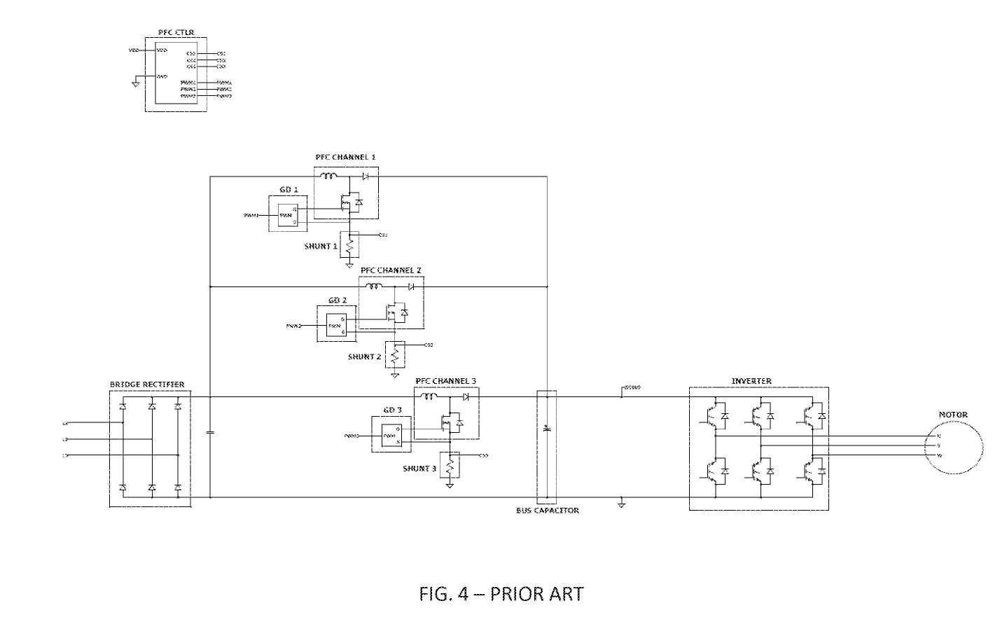

To facilitate an improvement in power factor for a three-phase system while also being able to accept single-phase input power and achieving unity power factor, a three-phase bridge can replace the single-phase bridge in the interleaved boost topology of FIG. 3. Such a circuit is depicted in FIG. 4, which is representative of the topology disclosed in U.S. Patent No. 10,186,956, titled “Universal voltage and phase input power supply for electrical motors.”

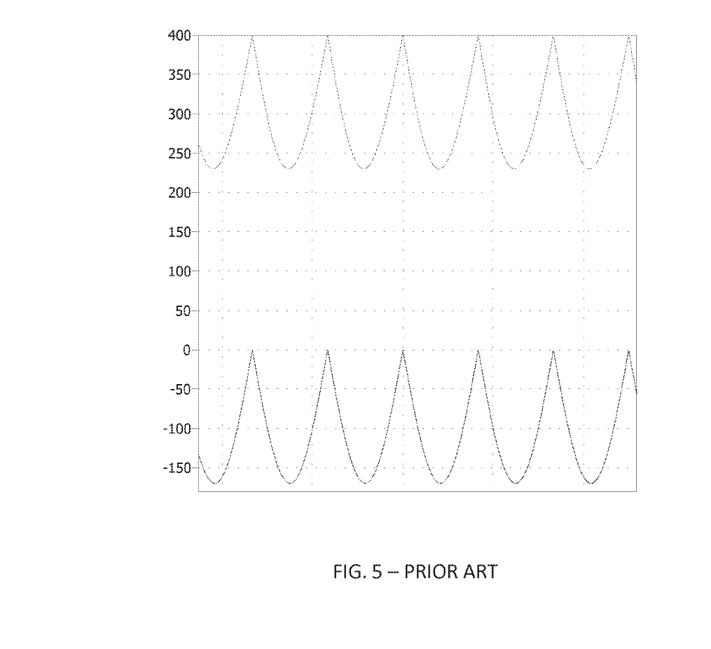

A side effect of an active power factor correction circuit is the bus voltage, DC+ to DC-, is boosted above the input source voltage peak. As configured, if the input AC voltage is sourced from a North American residential split-phase transformer, then the summation of the average voltage of the DC+ to Earth Ground and DC- to Earth Ground, defined as the DC bias voltage, is non-zero and positive. These voltages are depicted in FIG. 5.

As shown in FIG. 5, in one example the average of the DC+ to Earth Ground is approximately 291V and the average of the DC- to Earth Ground is approximately -108V. The DC bias voltage is thus approximately 183V. As such, the inverter output voltage average measured from any motor phase to Earth Ground will also have a positive DC bias which is present on the entirety of the phase wire.

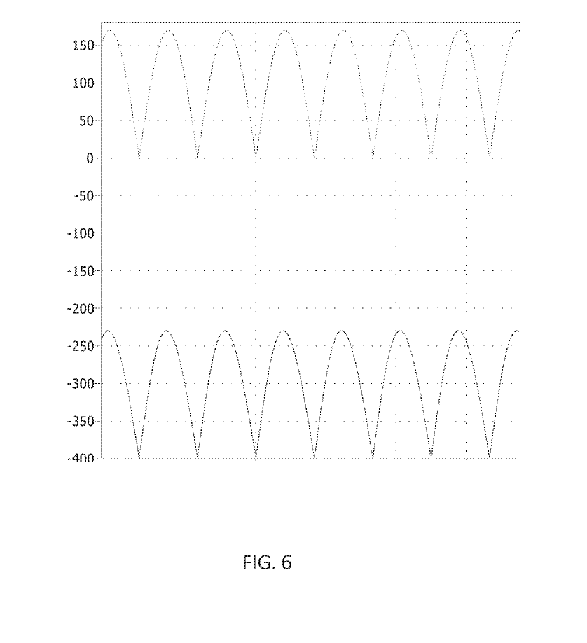

As shown in FIG. 6, the topology according to one embodiment of the present disclosure eliminates this positive DC bias. In one example, the average of the DC+ to Earth Ground is approximately 108V and the average of the DC- to Earth Ground is approximately -291V. The DC bias voltage is thus approximately -183V. As such, the inverter output voltage average measured from any motor phase to Earth Ground will also have a negative DC bias which is present on the entirety of the phase wire.

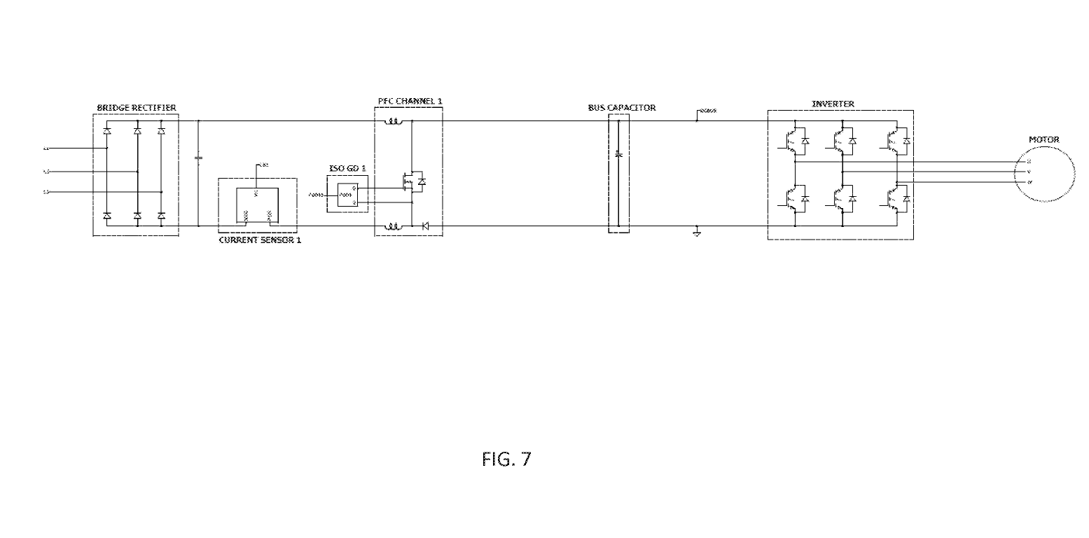

Referring now to FIG. 7, another embodiment of the present disclosure is shown as a single channel derivative of the reverse interleaved boost power factor correction circuit of FIG. 1. In this embodiment, the inductor is split among the positive and negative side of the rectifier to satisfy a common mode noise reduction method known as the General Balancing Technique. In one embodiment, at least three input connections are provided, each being configured to receive a conductor of an AC power source. It should be understood, however, that the system may readily be configured for a single-phase input. A rectifier is electrically connected to at least three input connections. The rectifier includes a plurality of diodes configured to rectify single phase AC power or three phase AC power. The rectifier has a positive side and negative side of the output. A capacitor is electrically connected in parallel to the rectifier output. An active power factor correction circuit is electrically connected to the rectifier output. The active power factor correction circuit includes a current sensor with a positive side and negative side couplable to the negative side of the rectifier. A first end of a first inductor is coupled to the positive side of the current sensor. A cathode of a boost diode is coupled to the second end of the inductor. The anode of the boost diode is coupled to the DC- of the active power correction circuit.

A power semiconductor transistor switch is provided with a drain coupled to the DC+ of the active power factor correction circuit, a source coupled to both the second end of the first inductor and the cathode of the boost diode, and a gate. While FIG. 7 depicts the switch as an N-channel metal oxide semiconductor field effect transistor (“MOSFET”), any suitable power semiconductor switch may be used, such as an insulated-gate bipolar transistor, wherein references above to the source would be replaced with the collector and references to the drain would be replaced with the emitter. An isolated gate driver circuit includes a gate connection coupled to the gate of the power semiconductor switch gate and a source connection coupled to the source of the power semiconductor switch. A second inductor is coupled at a first end to the positive side of the rectifier and at a second end to the DC+ of the active power factor correction circuit. A bus capacitor bank includes a positive end and a negative end. The positive end is coupled to the DC+ of the active power factor correction circuit and negative end is coupled to the DC- of the active power factor correction circuit. A controller (not shown) is configured to electrically connect the second inductor to DC+ of the active power factor correction circuit and to electrically connect the first inductor to the negative end of the bus capacitor to charge the capacitor through the inductors and the diode in the active power factor correction circuit with current from the diode in the active power factor correction circuit.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

As used herein, the modifier “about” or “approximately” used in connection with a quantity is inclusive of the stated value and has the meaning dictated by the context (for example, it includes at least the degree of error associated with the measurement of the particular quantity). When used in the context of a range, the modifier “about” or “approximately” should also be considered as disclosing the range defined by the absolute values of the two endpoints. For example, the range “from about 2 to about 4” also discloses the range “from 2 to 4.”

It should be understood that the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B or C may be present in a single embodiment; for example, A and B, A and C, B and C, or A and B and C.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art with the benefit of the present disclosure to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

What is claimed is:

1. A drive circuit, comprising:
a rectifier configured to rectify AC power;
a capacitor coupled in parallel to an output of the rectifier;
a power factor correction (“PFC”) circuit coupled to the rectifier output and having a DC+ node and a DC- node;
a bus capacitor having a positive end coupled to the DC+ node and a negative end coupled to the DC- node;
wherein the PFC circuit includes a plurality of channels, each channel comprising:
a current sensor having a negative side coupled to a negative side of the rectifier output;
a switch having an output node coupled to the DC+ node;
an inductor coupled between a positive side of the current sensor and an input node of the switch;
a diode having a cathode coupled to the input node of the switch and an anode coupled to the DC- node; and
a driver circuit having a control connection coupled to a control node of the switch and an input connection coupled to the input node of the switch; and
a controller configured to control the PFC circuit to connect the inductor of each of the plurality of channels to the DC+ node independently of inductors of other channels of the plurality of channels, and to connect the inductor of each of the plurality of channels to the DC- node independently of inductors of other channels of the plurality of channels to charge the bus capacitor through the inductors and the diodes of each of the plurality of channels independently with current from the diodes of the plurality of channels.

2. The drive circuit of claim 1, wherein the rectifier is a three phase rectifier.

3. The drive circuit of claim 1, further comprising an inverter configured to receive a DC signal from the PFC circuit and provide a pulse width modulated output voltage to a motor.

4. The drive circuit of claim 3, wherein an average of the output voltage of the inverter has a negative DC bias.

5. The drive circuit of claim 1, wherein the switch is a MOSFET.

6. A drive circuit, comprising:
a rectifier configured to rectify AC power;
a capacitor coupled in parallel to an output of the rectifier;
a power factor correction (“PFC”) circuit coupled to the rectifier output and having a DC+ node and a DC- node;
a bus capacitor having a positive end coupled to the DC+ node and a negative end coupled to the DC- node;
wherein the PFC circuit includes at least one channel comprising:
a current sensor having a negative side coupled to a negative side of the rectifier output;
a switch having an output node coupled to the DC+ node;
a first inductor coupled between a positive side of the current sensor and an input node of the switch;
a diode having a cathode coupled to the input node of the switch and an anode coupled to the DC- node;
a second inductor coupled between a positive side of the rectifier output and the output node of the switch; and
a driver circuit having a control connection coupled to a control node of the switch and an input connection coupled to the input node of the switch; and
a controller configured to control the PFC circuit to connect the second inductor to the positive end of the bus capacitor and to connect the first inductor to the negative end of the bus capacitor to charge the bus capacitor through the first inductor, the second inductor and the diode with current from the diode.

7. The drive circuit of claim 6, wherein the rectifier is a three phase rectifier.

8. The drive circuit of claim 6, further comprising an inverter configured to receive a DC signal from the PFC circuit and provide a pulse width modulated output voltage to a motor.

9. The drive circuit of claim 8, wherein an average of the output voltage of the inverter has a negative DC bias.

10. A method of providing power factor correction of a drive signal for a motor, comprising:
rectifying an AC power input with a rectifier;
coupling a capacitor in parallel with an output of the rectifier;
coupling a power factor correction (“PFC”) circuit to the rectifier output, the PFC circuit having a DC+ node and a DC- node;
smoothing an output of the PFC circuit with a bus capacitor having a positive end coupled to the DC+ node and a negative end coupled to the DC- node;
wherein the PFC circuit includes a plurality of channels, each channel comprising:
a current sensor having a negative side coupled to a negative side of the rectifier output;
a switch having an output node coupled to the DC+ node;
an inductor coupled between a positive side of the current sensor and an input node of the switch;
a diode having a cathode coupled to the input node of the switch and an anode coupled to the DC- node; and
a driver circuit having a control connection coupled to a control node of the switch and an input connection coupled to the input node of the switch; and
controlling the PFC circuit to connect the inductor of each of the plurality of channels to the DC+ node independently of inductors of other channels of the plurality of channels, and to connect the inductor of each of the plurality of channels to the DC- node independently of inductors of other channels of the plurality of channels to charge the bus capacitor through the inductors and the diodes of each of the plurality of channels independently with current from the diodes of the plurality of channels.

11. The method of claim 10, wherein the rectifier is a three phase rectifier.

12. The method of claim 10, further comprising converting a DC signal from the PFC circuit with an inverter to provide a pulse width modulated output voltage to the motor.

13. The method of claim 12, wherein an average of the output voltage of the inverter has a negative DC bias.

14. The method of claim 10, wherein the switch is a MOSFET.
